(19) United States
(12) Patent Application Publication
(10) Pub. No.: US 2024/0063506 A1
(43) Pub. Date: Feb. 22, 2024

(54) BATTERY SEPARATOR COATING

(71) Applicant: SOLVAY SPECIALTY POLYMERS ITALY S.P.A., Bollate (Milano) (IT)

(72) Inventors: Andrea Vittorio Oriani, Milan (IT); Matilde Valeria Solmi, Ispra Varese (IT); Mirko Mazzola, Milan (IT)

(73) Assignee: SOLVAY SPECIALTY POLYMERS ITALY S.P.A., Bollate (Milano) (IT)

(21) Appl. No.: 18/258,657

(22) PCT Filed: Dec. 9, 2021
(86) PCT No.: PCT/EP2021/084968

§ 371 Date: Jun. 21, 2023

(30) Foreign Application Priority Data
Dec. 21, 2020 (EP) 20216012.3

(51) Int. Cl. H01M 50/426; H01G 11/52; H01M 50/403; H01M 50/417; H01M 50/451; H01M 50/454; H01M 50/457

(52) U.S. Cl. CPC H01M 50/426; H01G 11/52; H01M 50/403; H01M 50/417; H01M 50/451; H01M 50/454; H01M 50/457

(57) ABSTRACT

The present invention pertains to a coating composition comprising a vinylidene fluoride polymer aqueous dispersion and to its use for the manufacture of electrochemical cell components, such as separators.

### CROSS-REFERENCE TO RELATED APPLICATIONS

This application claims priority to European application No. 20216012.3 filed on 21 Dec. 2020, the whole content of this application being incorporated herein by reference for all purposes.

### TECHNICAL FIELD

The present invention pertains to a coating composition comprising a vinylidene fluoride polymer and to its use for the manufacture of electrochemical cell components, such as separators.

### BACKGROUND ART

Lithium-ion batteries have become essential in our daily life. In the context of sustainable development, they are expected to play a more important role because they have attracted increasing attention for uses in electric vehicles and renewable energy storage.

Separator layers are important components of batteries. These layers serve to prevent contact of the anode and cathode of the battery while permitting electrolyte to pass there through. Additionally, battery performance attributes such as cycle life and power can be significantly affected by the choice of separator.

Vinylidene fluoride (VDF) polymers are known in the art to be suitable as binders for the manufacture of electrodes and/or composite separators, and/or as coatings of porous separators for use in non-aqueous-type electrochemical devices such as batteries, preferably secondary batteries, and electric double layer capacitors.

However, some VDF polymers used in separator coating compositions have high solubility in electrolyte solutions, and once dissolved in the electrolyte solution they are free to move around the battery. This can cause problems in terms of higher electrolyte viscosity, increased resistance to lithium ion flow, capacity fading and cell assembly.

Lamination is an important process in battery cell assembly, having the effects of forming a homogeneous interphase between the electrodes and the separator, to reduce the defects before and during cycling and to make the assembly easier and could improve the battery performance characteristics. The lamination process includes the step of contacting a separator with the electrodes in a facing relationship under certain pressure and temperature conditions.

A properly laminated interface will often have lower impedance (resistance) than one that is not laminated, and would thereby improve the power characteristics of a cell.

A volumetric evolution of polymers after soaking in the electrolyte or the uptake of organic electrolyte due to electrolyte-binder interactions is named as physical swelling. Polymers that show some degree of swelling are usually those that allow for better lamination.

In the technical field of batteries, notably of lithium batteries, the problem of providing a coated separator capable of providing outstanding adhesion to the separator substrate material and to electrodes and does not dissolve in the electrolyte, is felt.

### SUMMARY OF INVENTION

Accordingly, the Applicant faced said problem by providing a composition suitable for coating the substrate material of a separator for an electrochemical cell, said coating composition being such to provide outstanding adhesion to the separator base material and to electrodes, to cathode in particular after soaking with electrolyte.

Surprisingly, the Applicant found that when a separator for an electrochemical cell is at least partially coated with a composition comprising at least one vinylidene fluoride (VDF)-based polymer having a high fraction of insoluble components in standard polar aprotic solvents, said problem can be solved.

At the same time, said coating composition shows a reduced solubility into the electrolyte solution, thus reducing the impact on ionic conductivity and improving the long term performances of the battery.

Thus, in a first aspect, the present invention relates to an aqueous composition [composition (C)] for use in the preparation of separators for electrochemical devices, said composition comprising at least one vinylidene fluoride (VDF)-based polymer [polymer (A)], said polymer (A) comprising more than 75.0% by moles of recurring units derived from vinylidene fluoride (VDF) monomer, wherein said polymer (A) satisfies the following requirements:
(I) having a fraction of insoluble component in N,N-dimethylacetamide (DMA) at 45° C. greater than 60% by weight; and
(II) having a degree of crystallinity obtained by DSC measurement of less than 48%.

In a second aspect, the present invention pertains to the use of the composition (C) of the invention in a process for the preparation of a separator for an electrochemical cell, said process comprising the following steps:
i) providing a non-coated substrate layer [layer (P)];
ii) providing composition (C) as defined above;
iii) applying said composition (C) obtained in step (ii) at least partially onto at least one portion of said substrate layer (P), thus providing an at least partially coated separator; and
iv) drying said at least partially coated separator obtained in step (iii).

In a further aspect, the present invention relates to a separator for an electrochemical cell comprising a substrate layer [layer (P)] at least partially coated with composition (C) as defined above.

In a further aspect, the present invention relates to an electrochemical cell, such as a secondary battery or a capacitor, comprising the at least partially coated separator as defined above.

### DESCRIPTION OF EMBODIMENTS

In the context of the present invention, the term “weight percent” (wt %) indicates the content of a specific component in a mixture, calculated as the ratio between the weight of the component and the total weight of the mixture. When referred to the recurring units derived from a certain monomer in a polymer/copolymer, weight percent (wt %) indicates the ratio between the weight of the recurring units of such monomer over the total weight of the polymer/copolymer. When referred to the total solid content of a liquid composition, weight percent (wt %) indicates the ratio between the weight of all non-volatile ingredients in the liquid.

By the term “separator”, it is hereby intended to denote a porous monolayer or multilayer polymeric material which electrically and physically separates electrodes of opposite polarities in an electrochemical cell and is permeable to ions flowing between them.

By the term “electrochemical cell”, it is hereby intended to denote an electrochemical cell comprising a positive electrode, a negative electrode and a liquid electrolyte, wherein a monolayer or multilayer separator is adhered to at least one surface of one of said electrodes.

Non-limitative examples of electrochemical cells include, notably, batteries, preferably secondary batteries, and electric double layer capacitors.

For the purpose of the present invention, by “secondary battery” it is intended to denote a rechargeable battery. Non-limitative examples of secondary batteries include, notably, alkaline or alkaline-earth secondary batteries.

The separator for an electrochemical cell of the present invention can advantageously be an electrically insulating composite separator suitable for use in an electrochemical cell. When used in an electrochemical cell, the composite separator is generally filled with an electrolyte which advantageously allows ionic conduction within the electrochemical cell.

By the term “aqueous”, it is hereby intended to denote a medium comprising pure water and water combined with other ingredients which do not substantially change the physical and chemical properties exhibited by water.

The at least one vinylidene fluoride (VDF)-based polymer [polymer (A)], comprises more than 75.0% by moles of recurring units derived from vinylidene fluoride (VDF) monomer.

Polymer (A) may further comprise recurring units derived from at least one hydrophilic (meth)acrylic monomer (MA) of formula:

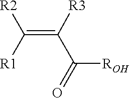

wherein each of R1, R2, R3, equal or different from each other, is independently an hydrogen atom or a C₁-C₃ hydrocarbon group, and R_{OH} is a hydroxyl group or a C₁-C₅ hydrocarbon moiety comprising at least one hydroxyl group.

The term “at least one hydrophilic (meth)acrylic monomer (MA)” is understood to mean that the polymer (A) may comprise recurring units derived from one or more than one hydrophilic (meth)acrylic monomer (MA) as above described. In the rest of the text, the expressions “hydrophilic (meth)acrylic monomer (MA)” and “monomer (MA)” are understood, for the purposes of the present invention, both in the plural and the singular, that is to say that they denote both one or more than one hydrophilic (meth)acrylic monomer (MA).

The hydrophilic (meth)acrylic monomer (MA) preferably complies with formula:

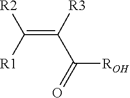

wherein each of R1, R2, R_{OH} have the meanings as above defined, and R3 is hydrogen; more preferably, each of R1, R2, R3 are hydrogen, while R_{OH} has the same meaning as above detailed.

Non limitative examples of hydrophilic (meth)acrylic monomers (MA) are notably acrylic acid, methacrylic acid, hydroxyethyl (meth)acrylate, hydroxypropyl(meth)acrylate; hydroxyethylhexyl(meth)acrylates.

The monomer (MA) is more preferably selected among:
hydroxyethylacrylate (HEA) of formula:

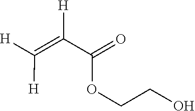

2-hydroxypropyl acrylate (HPA) of either of formulae:

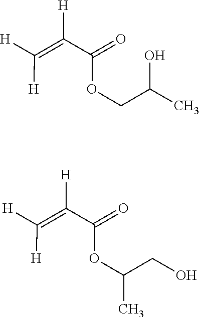

acrylic acid (AA) of formula:

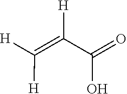

and mixtures thereof.

More preferably, the monomer (MA) is AA and/or HEA, even more preferably is AA.

Determination of the amount of (MA) monomer recurring units in polymer (A) can be performed by any suitable method. Mention can be notably made of acid-base titration methods, well suited e.g. for the determination of the acrylic acid content, of NMR methods, adequate for the quantification of (MA) monomers comprising aliphatic hydrogens in side chains (e.g. HPA, HEA), of weight balance based on total fed (MA) monomer and unreacted residual (MA) monomer during polymer (A) manufacture and of IR methods.

Should at least one hydrophilic (meth)acrylic monomer (MA) be present, the polymer (A) comprises typically from 0.05 to 10.0% by moles, with respect to the total moles of recurring units of polymer (A).

The polymer (A) may further comprise recurring units derived from at least one other comonomer (CM) different from VDF and from monomer (MA), as above detailed.

The comonomer (CM) can be either a hydrogenated comonomer [comonomer (H)] or a fluorinated comonomer [comonomer (F)].

By the term “hydrogenated comonomer [comonomer (H)]”, it is hereby intended to denote an ethylenically unsaturated comonomer free of fluorine atoms.

Non-limitative examples of suitable hydrogenated comonomers (H) include, notably, ethylene, propylene, vinyl monomers such as vinyl acetate, as well as styrene monomers, like styrene and p-methylstyrene.

By the term “fluorinated comonomer [comonomer (F)]”, it is hereby intended to denote an ethylenically unsaturated comonomer comprising at least one fluorine atom.

The comonomer (CM) is preferably a fluorinated comonomer [comonomer (F)].

Non-limitative examples of suitable fluorinated comonomers (F) include, notably, the followings:
(a) C₂-C₈ fluoro- and/or perfluoroolefins such as tetrafluoroethylene (TFE), hexafluoropropylene (HFP), pentafluoropropylene and hexafluoroisobutylene;
(b) C₂-C₈ hydrogenated monofluoroolefins such as vinyl fluoride, 1,2-difluoroethylene and trifluoroethylene;
(c) perfluoroalkylethylenes of formula CH₂═CH—R_{f0}, wherein R_{f0} is a C₁-C₈ perfluoroalkyl group;
(d) chloro- and/or bromo- and/or iodo-C₂-C₆ fluoroolefins such as chlorotrifluoroethylene (CTFE);
(e) (per)fluoroalkylvinylethers of formula CF₂═CFOR_{f1}, wherein R_{f1} is a C₁-C₆ fluoro- or perfluoroalkyl group, e.g. —CF₃, —C₂F₅, —C₃F₇;
(f) (per)fluoro-oxyalkylvinylethers of formula CF₂═CFOX₀, wherein X₀ is a C₁-C₁₂ oxyalkyl group or a C₁-C₁₂ (per)fluorooxyalkyl group having one or more ether groups, e.g. perfluoro-2-propoxy-propyl group;
(g) fluoroalkyl-methoxy-vinylethers of formula CF₂═CFOCF₂OR_{f2}, wherein R_{f2} is a C₁-C₆ fluoro- or perfluoroalkyl group, e.g. —CF₃, —C₂F₅, —C₃F₇ or a C₁-06 (per)fluorooxyalkyl group having one or more ether groups, e.g. —C₂F₅—O—CF₃;
(h) fluorodioxoles of formula:

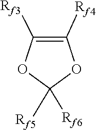

wherein each of R_{f3}, R_{f4}, R_{f5} and R_{f6}, equal to or different from each other, is independently a fluorine atom, a C₁-C₆ fluoro- or per(halo)fluoroalkyl group, optionally comprising one or more oxygen atoms, e.g. —CF₃, —C₂F₅, —C₃F₇, —OCF₃, —OCF₂CF₂OCF₃.

Most preferred fluorinated comonomers (F) are tetrafluoroethylene (TFE), trifluoroethylene (TrFE), chlorotrifluoroethylene (CTFE), hexafluoropropylene (HFP), perfluoromethyl vinyl ether (PMVE), perfluoropropyl vinyl ether (PPVE) and vinyl fluoride, and among these, HFP is most preferred.

Should at least one comonomer (CM) (preferably HFP) be present, it is present in polymer (A) in an amount typically of from 0.05% to 25.0% by moles, preferably from 0.5% to 5% by moles, with respect to the total moles of recurring units of polymer (A).

However, it is necessary that the amount of recurring units derived from vinylidene fluoride in the polymer (A) is at least 75.0% by moles, preferably at least 90.0% by moles, more preferably at least 95.0% by moles, so as not to impair the excellent properties of vinylidene fluoride resin, such as chemical resistance, weatherability, and heat resistance.

According to certain embodiments, polymer (A) consists essentially of recurring units derived from VDF and from comonomer (F).

According to other embodiments, polymer (A) consists essentially of recurring units derived from VDF, and from HFP.

Polymer (A) may still comprise other moieties such as defects, end-groups and the like, which do not affect nor impair its physico-chemical properties.

The composition (C) may further comprise one or more than one additional additive.

Optional additives in composition (C) include notably viscosity modifiers, as detailed above, anti-foams, dispersing agents, non-fluorinated surfactants, and the like.

Among non-fluorinated surfactants, mention can be made of non-ionic emulsifiers, such as notably alkoxylated alcohols, e.g. ethoxylates alcohols, propoxylated alcohols, mixed ethoxylated/propoxylated alcohols; of anionic surfactants, including notably fatty acid salts, alkyl sulfonate salts (e.g. sodium dodecyl sulfate), alkylaryl sulfonate salts, arylalkyl sulfonate salts, and the like; of organically modified siloxanes, such as siloxanes modified with polyether, primary hydroxyl groups or double bonds-bearing side chains.

Among dispersing agents, acrylate copolymers can be mentioned.

The composition (C) may further comprise a co-binder. The term “co-binder” is hereby intended to denote a substance that improves the strength of the dried coating as well as influences the rheology of the wet coating. Suitable examples of co-binders that can be added to composition (C) are polymers or modified polymers of acrylic acid, acrylic esters, styrene-acrylic acid esters, vinylalcohol (PVA) or acrylonitrile (PAN).

Typically, the total solid content of the composition (C) ranges between 5 and 50% by weight over the total weight of the composition (C).

The total solid content of the composition (C) is understood to be cumulative of all non-volatile ingredients thereof.

The amount of polymer (A) used in the aqueous composition (C) of the present invention, will vary from about 2.0 to 97.0% by weight, wherein said weight percentage is based on the total solid content weight of the composition (C).

Composition (C) is particularly suitable for the coating of surfaces, particularly of porous surfaces such as that of separators for electrochemical cells.

The aqueous composition according to the invention is particularly advantageous for the preparation of coated or semi-coated separators suitable for use in Lithium-based secondary batteries, such as lithium-ion and lithium metal secondary batteries.

In one aspect, the present invention thus pertains to the use of the aqueous composition (C) in a process for the preparation of a separator for an electrochemical cell, said process comprising the following steps:
i) providing a non-coated substrate layer [layer (P)];
ii) providing composition (C) as defined above;
iii) applying said composition (C) obtained in step (ii) at least partially onto at least one portion of said substrate layer (P), thus providing an at least partially coated separator; and
iv) drying said at least partially coated separator obtained in step (iii).

In the context of the invention, the term “substrate layer” is hereby intended to denote either a monolayer substrate consisting of a single layer or a multilayer substrate comprising at least two layers adjacent to each other.

The substrate layer (P) may be either a non-porous substrate layer or a porous substrate layer. Should the substrate layer be a multilayer substrate, the outer layer of said substrate may be either a non-porous substrate layer or a porous substrate layer. By the term “porous substrate layer”, it is hereby intended to denote a substrate layer containing pores of finite dimensions.

In a preferred embodiment of the present invention, the substrate layer (P) is a multilayer substrate including a porous layer comprising a ceramic material and a fabric layer.

Preferred ceramic materials may include, but are not limited to, Pb(Zr,Ti)O₃ (PZT), Pb₁₋ₓLaₓZr_{1-y}Ti_{y}O₃ (PLZT, x and y are independently between 0 and 1), PB(Mg₃Nb_{2/3})O₃—PbTiO₃ (PMN-PT), BaTiO₃, HfO₂ (hafnia), SrTiO₃, TiO₂ (titania), SiO₂ (silica), Al₂O₃ (alumina), ZrO₂ (zirconia), SnO₂, CeO₂, MgO, CaO, Y₂O₃ and any combination thereof.

The fabric layer can be made by any fabric commonly used for a separator in electrochemical device, comprising at least one material selected from the group consisting of polyethyleneterephthalate, polybutyleneterephthalate, polyester, polyacetal, polyamide, polycarbonate, polyimide, polyetheretherketone, polyethersulfone, polyphenyleneoxide, polyphenylenesulfide, polyethylenenaphthalene, polyvinylidene fluoride, polyethyleneoxide, polyacrylonitrile, polyethylene and polypropylene, or their mixtures. Preferably, the substrate (P) is polyethylene or polypropylene.

The layer (P) has typically a porosity advantageously of at least 5%, preferably of at least 10%, more preferably of at least 20% or at least 40% and advantageously of at most 90%, preferably of at most 80%.

The thickness of layer (P) is not particularly limited and is typically from 3 to 100 micrometer, preferably form 5 and 50 micrometer.

In step iii) of the process of the invention, the composition (C) is typically applied onto at least one surface of the layer (P) by a technique selected from casting, spray coating, rotating spray coating, roll coating, doctor blading, dip coating, slot die coating, gravure coating, ink jet printing, spin coating and screen printing, brush, squeegee, foam applicator, curtain coating, vacuum coating.

The ratio between the weight of the coating and the weight of the support layer in the at least partially coated separator according to the invention is typically 3:1 to 0.5:1, such as 2:1, 1.5:1, 1:1 or 0.75:1.

In step iv) of the method of the invention, the coating composition layer is dried preferably at a temperature comprised between 25° C. and 200° C., preferably between 60° C. and 180° C.

In a further aspect, the present invention relates to a separator for an electrochemical cell comprising a substrate layer [layer (P)] at least partially coated with composition (C) as defined above.

The Applicant has surprisingly found that polymer (A), which is characterized by a certain degree of crystallinity and a high fraction of insoluble component in standard polar aprotic solvents, when used in aqueous composition (C) of the invention lead to the formation of a high gel fraction when contacted with the electrolyte.

Thanks to the formation of said high gel fraction, aqueous composition (C) including polymer (A) shows a reduced solubility in the electrolyte solution, thus the polymer (A) is not free to move around in the battery and the viscosity of the electrolyte is not modified. This results in reducing the impact on ionic conductivity and improving the long term performances of the battery.

In particular, polymer (A) has a very limited solubility in alkyl carbonates.

At the same time, polymer (A) shows a suitable swelling when contacted with the electrolyte, which allows to reach an outstanding adhesion to both the substrate material and to electrodes, and consequently a good lamination strength.

Composition (C) comprising polymer (A) is thus particularly suitable for use in compositions for coating the substrate material of a separator for an electrochemical cell, thanks to the outstanding adhesion to the separator base material and to electrodes, to cathode in particular.

Should the disclosure of any patents, patent applications, and publications which are incorporated herein by reference conflict with the description of the present application to the extent that it may render a term unclear, the present description shall take precedence.

The invention is described hereunder in more detail with reference to the following examples, which are provided with the purpose of merely illustrating the invention, with no intention to limit its scope.

### EXPERIMENTAL PART

Raw Materials

Kynar Flex® LBG (LBG), commercially available from Arkema.

### Example 1—Manufacture of Aqueous VDF-HFP Polymer Latex—Polymer A1

In a 21 lt. horizontal reactor autoclave equipped with baffles and stirrer working at 50 rpm, 13.5 lt. of deionized water were introduced. The temperature was brought to 110° C. then the pressure of 42 Bar Ass was maintained constant throughout the whole trial by feeding VDF/HFP gaseous mixture monomers in a molar ratio of 98:2 respectively. 60 mL of a 1:1 aqueous solution of ammonium persulfate (APS) and sodium acetate (NaOAc) 10.8 g/L were added over a period of 4 minutes (900 mL/h).

After 30 minutes from the ignition, the addition of the APS/NaOAc 1:1 solution was restarted with a flux rate of 60 mL/h for the whole duration of the trial.

When 4000 g of the mixture were fed, the feeding mixture was interrupted, then the pressure was let to fall down for 30 min while keeping the reaction temperature constant. Final reaction time was 185 min.

The reactor was cooled to room temperature and an aqueous latex having a solid content of 23.8% by weight was recovered.

The VDF-HFP polymer so obtained contained 1.6% by moles of HFP and was found to possess a melting point (Tm2) of 149° C. and a crystallinity degree of 40.4 J/g (determined according to ASTM D3418), a Mw of 814 kDalton and an insoluble fraction of 76%.

### Example 2—Manufacture of Aqueous VDF-HFP Polymer Latex—Polymer A2

In a 21 lt. horizontal reactor autoclave equipped with baffles and stirrer working at 50 rpm, 13.5 lt. of deionized water were introduced. The temperature was brought to 110° C. then the pressure of 42 Bar Ass was maintained constant throughout the whole trial by feeding VDF/HFP gaseous mixture monomers in a molar ratio of 99.5:0.5 respectively. 60 mL of a 1:1 aqueous solution of ammonium persulfate (APS) and sodium acetate (NaOAc) 10.8 g/L were added over a period of 4 minutes (900 mL/h).

After 30 minutes from the ignition, the addition of the APS/NaOAc 1:1 solution was restarted with a flux rate of 60 mL/h for the whole duration of the trial.

When 4000 g of the mixture were fed, the feeding mixture was interrupted, then the pressure was let to fall down for 30 min while keeping the reaction temperature constant. Final reaction time was 155 min.

The reactor was cooled to room temperature and latex was recovered.

The aqueous latex so obtained had a solid content of 23.5% by weight. The VDF-HFP polymer so obtained contained 0.4% by moles of HFP and was found to possess a melting point (Tm2) of 155° C. and a crystallinity degree of 46.2 J/g (determined according to ASTM D3418), a Mw of 832 kDalton and an insoluble fraction of 78%.

### Example 3—Manufacture of Aqueous VDF-HFP Polymer Latex—Polymer A3

In a 21 lt. horizontal reactor autoclave equipped with baffles and stirrer working at 50 rpm, 13.5 lt. of deionized water were introduced. The temperature was brought to 110° C. then the pressure of 42 Bar Ass was maintained constant throughout the whole trial by feeding VDF/HFP gaseous mixture monomers in a molar ratio of 99:1 respectively. 60 mL of a 1:1 aqueous solution of ammonium persulfate (APS) and sodium acetate (NaOAc) 10.8 g/L were added over a period of 4 minutes (900 mL/h).

After 30 minutes from the ignition, the addition of the APS/NaOAc 1:1 solution was restarted with a flux rate of 60 mL/h for the whole duration of the trial.

When 4000 g of the mixture were fed, the feeding mixture was interrupted, then the pressure was let to fall down for 30 min while keeping the reaction temperature constant. Final reaction time was 163 min.

The reactor was cooled to room temperature and latex was recovered.

The aqueous latex so obtained had a solid content of 24.1% by weight. The VDF-HFP polymer so obtained contained <1% by moles of HFP and was found to possess a melting point (Tm2) of 152° C. and a crystallinity degree of 43.5 J/g (determined according to ASTM D3418), a Mw of 849 kDalton and an insoluble fraction of 80%.

### Example 4—Manufacture of Aqueous VDF Polymer Latex—Polymer A4

In a 21 lt. horizontal reactor autoclave equipped with baffles and stirrer working at 50 rpm, 13.5 lt. of deionized water were introduced. The temperature was brought to 110° C. then the pressure of 50 Bar Ass was maintained constant throughout the whole trial by feeding VDF gaseous monomer. 60 mL of a 1:1 aqueous solution of ammonium persulfate (APS) and sodium acetate (NaOAc) 10.8 g/L were added over a period of 10 minutes (360 mL/h).

After 30 minutes from the ignition restart to add the solution of ammonium persulfate (APS) with a flux rate of 60 mL/h for the whole duration of the trial.

When 4000 g of VDF were fed, the feeding was interrupted, then the pressure was let to fall down for 30 min while keeping the reaction temperature constant. Final reaction time was 162 min.

The reactor was cooled to room temperature and latex was recovered.

The aqueous latex so obtained had a solid content of 23.5% by weight. The VDF polymer so obtained contained was found to possess a melting point (Tm2) of 157° C. and a crystallinity degree of 47.5 J/g (determined according to ASTM D3418), a Mw of 773 kDalton and an insoluble fraction of 64%.

### Comparative Example 1—Manufacture of Aqueous VDF Polymer Latex—Polymer C1

In a 21 lt. horizontal reactor autoclave equipped with baffles and stirrer working at 50 rpm, 13.5 lt. of deionized water were introduced. The temperature was brought to 122.5° C. then the pressure of 46 Bar Ass was maintained constant throughout the whole trial by feeding VDF gaseous monomer. 70 mL of a pure di-ter-butyl peroxide (DTBP) solution and 300 mL of an aqueous solution of ammonium persulfate (APS) 0.9 g/L were added.

When 200 g of VDF were fed, an aqueous solution of sodium dodecyl sulfate (SDS) 3.26 g/L were fed with a flux rate of 40 mL every 200 g of VDF fed for the whole duration of the trial. Total SDS at the end of the reaction was 760 mL.

When 4000 g of VDF were fed, the feeding was interrupted, then the pressure was let to fall down for 30 min while keeping the reaction temperature constant. Final reaction time was 216 min.

The reactor was cooled to room temperature and latex was recovered.

The aqueous latex so obtained had a solid content of 21.2% by weight. The VDF polymer so obtained was found to possess a melting point (Tm2) of 149° C. and a crystallinity degree of 40.4 J/g (determined according to ASTM D3418), a Mw of 508 kDalton and an insoluble fraction of <3%.

### Comparative Example 2—Manufacture of Aqueous VDF-HFP Polymer Latex—Polymer C2

In a 21 lt. horizontal reactor autoclave equipped with baffles and stirrer working at 50 rpm, 13.5 lt. of deionized water were introduced. The temperature was brought to 125° C. then the pressure of 50 Bar Ass was maintained constant throughout the whole trial by feeding VDF/HFP gaseous mixture monomers in a molar ratio of 98:2 respectively. 70 mL of a pure di-ter-butyl peroxide (DTBP) solution and 120 mL of an aqueous solution of ammonium persulfate (APS) 6.75 g/L were added.

When 200 g of VDF were fed, the reaction temperature was reduced to 115° C. and an aqueous solution of sodium dodecyl sulfate (SDS) 3.26 g/L were fed with a flux rate of 40 mL every 200 g of VDF fed for the whole duration of the trial. Total SDS at the end of the reaction was 760 mL.

When 4000 g of VDF were fed, the feeding was interrupted, then the pressure was let to fall down for 30 min while keeping the reaction temperature constant. Final reaction time was 263 min.

The reactor was cooled to room temperature and latex was recovered.

The aqueous latex so obtained had a solid content of 22.0% by weight. The VDF-HFP polymer so obtained contained 1.5% by moles of HFP and was found to possess a melting point (Tm2) of 155° C. and a crystallinity degree of 44.9 J/g (determined according to ASTM D3418), a Mw of 632 kDalton and an insoluble fraction of 6%.

General Procedure for the Determination of Insoluble Fraction in DMA.

A sample of the latex of examples A1 to A4 or of comparative examples C1 or C2 was dried by shear coagulation technique, submitting the said latex to centrifugation; a weighted amount (0.25% wt/vol concentration) of so obtained powder was dissolved for 4 hours under magnetic stirring at 45° C. in a solution of N,N-dimethylacetamide (DMA)+LiBr 0.01N, in a weight ratio 1:375. After cooling at room temperature, the solution was centrifuged at 20,000 rpm for 1 hour using a Sorvall RC-6 Plus centrifuge (rotor model: F21S-8X50Y).

The insoluble fraction was separated and quantified after drying at 150° C. for 48 hours, and dividing the same by the overall weight of the coagulated powder specimen the insoluble fraction was determined.

General Procedure for the Determination of Weight Average Molecular (Mw) in DMA.

A sample of the obtained latex was dried by shear coagulation technique, submitting the said latex to centrifugation; a weighted amount (0.25% wt/vol concentration) of so obtained powder was dissolved for 4 hours under magnetic stirring at 45° C. in a solution of N,N-dimethylacetamide (DMA)+LiBr 0.01N, in a weight ratio 1:375. After cooling at room temperature, the solution was centrifuged at 20,000 rpm for 1 hour using a Sorvall RC-6 Plus centrifuge (rotor model: F21S-8X50Y).

The supernatant of each sample was analyzed using instrumentation and conditions below detailed:
Mobile phase: DMA
Flow rate: 1 mL/min.
Temperature: 45° C.
Injection system: Waters 717plus Autosampler.
Injection volume: 200 μL.
Pump: Waters Isocratic Pump model 1515.
Columns: Four Water Styragel HT (300×7.5) mm, 10 μm particle size: Styragel HT-6, HT-5, HT-4, HT-3 with guard column.
Detector: Waters refractive index model 2414.
Software for data acquisition and processing: Waters Empower.

General Procedure for the Determination of Solubility of VDF-Based Polymers in Propylene Carbonate

Propylene carbonate (PC) is poured in a glass vessel with a stirring bar. A polymer powder obtained by drying any of latex of examples A1 to A4 or of comparative examples C1 or C2 by shear coagulation technique, submitting the said latex to centrifugation, is added to PC under stirring on a magnetic plate at 90° C. The concentration generally used is 2.5% by weight (i.e. 0.5 g of polymer and 19.5 g of PC). The solution/dispersion is kept at 90° C. under stirring for 2 h.

After the 2 h, the solution/dispersion is centrifuged at 20000 rpm for 1 h. The solid separates from the liquid part (supernatant). The supernatant is further analyzed to check the total solid content (using a thermobalance) and the viscosity.

Total Solid Content Measurement:

About 4 g of liquid are spread on an aluminum pan with a glass fiber filter on it. The solution is covered with another glass fiber filter to avoid loss of mass due to boiling. The material is heated up to 155° C. in 3 minutes and the temperature is kept until the weight change is below 1 mg in 50 seconds.

The balance give the % of solid residues in the solution.

The dissolved polymer is calculated with the following formula:

% of dissolved polymer=TSC_{90° C.}/TSCᵢₙᵢₜᵢₐₗ×100

General Procedure for the Determination of the Degree of Swelling of VDF-Based Polymers in Alkyl Carbonates

Degree of swelling after soaking a specimen (disc of polymer having thickness 1.5 mm and diameter 25 mm obtained by compression molding powders obtained as above described) of Polymers A1 to A4 and comparative VDF-based polymers C1 or C2 was determined in EC:DMC:DEC (1:1:1 vol) at 45° C. was determined as change in mass according to ASTM D471.

The results are shown in Table 1.

TABLE 1

| | Insoluble | Monomer | | | | |
|---|---|---|---|---|---|---|
| | Fraction | Content | | | | |
| | in DMAC | HFP | Tm2 | Crystallinity | Solu- | Swelling |
| | [%] | [mol %] | [° C.] | [J/g] | bility* | [%] |
| A1 | 76 | 1.6 | 149 | 40.4 | 3 | 41 |
| A2 | 78 | 0.4 | 155 | 46.2 | 3 | 29 |
| A3 | 80 | <1 | 152 | 43.5 | 3 | 32 |
| A4 | 64 | 0 | 157 | 47.5 | 3 | 27 |
| C1 | <3 | 0 | | | 1 | 23 |
| C2 | 6 | 1.5 | 155 | 44.9 | 1 | 37 |
| Ref. 1 | <3 | 2.2 | 152 | 39.3 | 1 | 36 |
| (LBG) | | | | | | |

```
*1: TSC > 50%
  2: 26% < TSC < 50%
  3: TSC ≤ 25%
```

The polymers A1 to A4, which present a better compromise between swelling and solubility in propylene carbonate, are particularly suitable for coating the substrate material of a separator for an electrochemical cell.

Viscosity Measurement:

The viscosity was measured with a Brookfield viscometer with a SC-21 spindle.

The viscosity of the PC is 2.6 cP.

The viscosity should be measured before the gelation of the dissolved polymer starts.

The results are shown in Table 2.

TABLE 2

| | Viscosity | Viscosity |
|---|---|---|
| | (Brookfield) | (Brookfield) |
| | within 6 h | within 24 h |
| | at RT | at RT |
| A1 | 3.3 | 4.26 |
| C2 | 17.6 | 42.8 |
| Ref. 1 | 19.1 | 67 |
| (LBG) | | |

The data show that the polymer A1 according to the present invention, thanks to the reduced solubility in the electrolyte solution, is not free to move around in the battery and the viscosity of the electrolyte is not modified. This is confirmed by the fact that the viscosity increase over 24 h is neglectable. Conversely, LBG and the polymer of Comparative Example 2 have high solubility in electrolyte solutions, and once dissolved in the electrolyte solution they are free to move around the battery causing problems in terms of higher electrolyte viscosity and corresponding increased resistance to lithium ion flow and capacity fading.

1. An aqueous composition [composition (C)] for use in the preparation of separators for electrochemical devices, said composition comprising:
at least one vinylidene fluoride (VDF)-based polymer [polymer (A)], said polymer (A) comprising more than 75.0% by moles of recurring units derived from vinylidene fluoride (VDF) monomer,
wherein said polymer (A) satisfies the following requirements:
having a fraction of insoluble component in N,N-dimethylacetamide (DMA) at 45° C. greater than 60% by weight; and
having a degree of crystallinity obtained by DSC measurement of less than 48%.

2. The composition (C) according to claim 1, wherein polymer (A) further comprises recurring units derived from at least one hydrophilic (meth)acrylic monomer (MA) of formula: 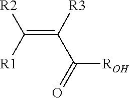
wherein each of R1, R2, R3, equal or different from each other, is independently a hydrogen atom or a C1-C3 hydrocarbon group, and ROH is a hydroxyl group or a C1-C5 hydrocarbon moiety comprising at least one hydroxyl group.

3. The composition (C) according to claim 2, wherein polymer (A) further comprises recurring units derived from at least a comonomer (CM), selected from a hydrogenated comonomer [comonomer (H)] or a fluorinated comonomer [comonomer (F)].

4. The composition (C) according to claim 3, wherein comonomer (CM) is a fluorinated comonomer [comonomer (F)] selected from the group consisting of:
(a) C2-C8 fluoro- and/or perfluoroolefins;
(b) C2-C8 hydrogenated monofluoroolefins;
(c) perfluoroalkylethylenes of formula CH2═CH—Rf0, wherein Rf0 is a C1-C6 perfluoroalkyl group;
(d) chloro- and/or bromo- and/or iodo-C2-C6 fluoroolefins;
(e) (per)fluoroalkylvinylethers of formula CF2═CFORf1, wherein Rf1 is a C1-C6 fluoro- or perfluoroalkyl group;
(f) (per)fluoro-oxyalkylvinylethers of formula CF2═CFOX0, wherein X0 is a C1-C12 oxyalkyl group or a C1-C12 (per)fluorooxyalkyl group having one or more ether groups;
(g) fluoroalkyl-methoxy-vinylethers of formula CF2═CFOCF2ORf2, wherein Rf2 is a C1-C6 fluoro- or perfluoroalkyl group; and
(h) fluorodioxoles of formula: 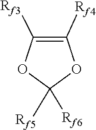
wherein each of Rf3, Rf4, Rf5 and Rf6, equal to or different from each other, is independently a fluorine atom, a C1-C6 fluoro- or per(halo)fluoroalkyl group, optionally comprising one or more oxygen atoms.

5. The composition (C) according to claim 4, wherein comonomer (CM) is selected from the group consisting of tetrafluoroethylene (TFE), trifluoroethylene (TrFE), chlorotrifluoroethylene (CTFE), hexafluoropropylene (HFP), perfluoromethyl vinyl ether (PMVE), perfluoropropyl vinyl ether (PPVE) and vinyl fluoride.

6. The composition (C) according to claim 3, wherein the at least one comonomer (CM) is present in an amount of from 0.05% to 25.0% by moles with respect to the total moles of recurring units of polymer (A).

7. The composition (C) according to claim 1, which further comprises one or more than one additional additive selected from the group consisting of viscosity modifiers, anti-foams, dispersing agents, non-fluorinated surfactants, and the like.

8. The composition (C) according to claim 1, which further comprises a co-binder.

9. A process for the preparation of a separator for an electrochemical cell, said process comprising the following steps:
i) providing a non-coated substrate layer [layer (P)];
ii) providing composition (C) according to of claim 1;
iii) applying said composition (C) obtained in step (ii) at least partially onto at least one portion of said substrate layer (P), thus providing an at least partially coated separator; and
iv) drying said at least partially coated separator obtained in step (iii).

10. The process according to claim 9, wherein layer (P) is a multilayer substrate including a porous layer comprising a ceramic material and a fabric layer.

11. The process according to claim 9, wherein in step iii) the composition (C) is applied onto at least one surface of the layer (P) by a technique selected from casting, spray coating, rotating spray coating, roll coating, dip coating, doctor blading, slot die coating, gravure coating, ink jet printing, spin coating and screen printing, brush, squeegee, foam applicator, curtain coating, and vacuum coating.

12. A separator for an electrochemical cell comprising a substrate layer at least partially coated with composition (C) according to claim 1.

13. An electrochemical cell comprising the at least partially coated separator according to claim 12.

14. The electrochemical cell of claim 13, wherein the cell is a secondary battery or a capacitor.

15. The composition (C) according to claim 4, wherein:
(a) the C2-C8 fluoro- and/or perfluoroolefins are selected from tetrafluoroethylene (TFE), hexafluoropropylene (HFP), pentafluoropropylene and hexafluoroisobutylene;
(b) the C2-C8 hydrogenated monofluoroolefins are selected from vinyl fluoride, 1,2-difluoroethylene and trifluoroethylene;
(d) the chloro- and/or bromo- and/or iodo-C₂-C₆ fluoroolefins is chlorotrifluoroethylene (CTFE);
(e) the Rf1 is CF3, —C2F5, —or C3F7;
(f) wherein X0 is perfluoro-2-propoxy-propyl group;
(g) the Rf2 is CF3, —C2F5, —C3F7 or a C1-C6 (per)fluorooxyalkyl group having one or more ether groups; and
(h) wherein each of Rf3, Rf4, Rf5 and Rf6 are selected from —CF3, —C2F5, —C3F7, —OCF3, —OCF2CF2OCF3.

16. The composition (C) according to claim 6, wherein the at least one comonomer (CM) is present in an amount of from 0.5% to 5.0% by moles, with respect to the total moles of recurring units of polymer (A)
